(19) United States
(12) Patent Application Publication
(10) Pub. No.: US 2005/0029322 A1
(43) Pub. Date: Feb. 10, 2005

(54) Method and device for wire feed

(75) Inventors: Alfred Vasilievich Ivannikov, St. Petersburg (RU); Igor Vladimirivich Suzdalev, St. Petersburg (RU); Yakov Oskarovich Shapiro, St. Petersburg (RU)

Correspondence Address: HOUSTON ELISEEVA, 4 MILITIA DRIVE, SUITE 4, LEXINGTON, MA, 02421, US

(73) Assignee: Otkritoe Aktsionernoe Obschestvo 'Zavod Elektrik', St. Petersburg (RU)

(21) Appl. No.: 10/912,970

(22) Filed: Aug. 6, 2004

(30) Foreign Application Priority Data
Aug. 7, 2003 (RU) RU2003124354

(51) Int. Cl. B65H 51/06

(52) U.S. Cl. 226/190

(57) ABSTRACT

A method of feeding a wire with a drive roller comprises guiding a bent wire into a guide groove of the driver roller at an angle of at least 0.5° relative to a tangent to the circumference of the drive roller at the entry point of the wire into the guide groove. The wire is pressed into the guide groove, bending the wire during pressing and engaging the wire with the guide groove. The engagement between the wire and the guide groove is maintained along a portion of the groove which is equal at least one diameter of the wire and is no longer than the length of the guide groove. The method further comprises guiding the sire away from the drive roller and straightening the wire by contraflexing it at an angle of at least 0.5° relative to a tangent to the circumference of the drive roller at the exit point. A device for feeding a wire has a drive roller with a guide groove, a guiding mechanism, a straightening mechanism and an engaging device and a pressing-in joint of the wire into the guide groove with at least two pressing-in components. The advantage of the method and device is in achieving higher pushing forces for guiding the wires over long distances, as well as high quality straightening of the wire.

This application claims priority to Russian application serial number RU 2003124354 filed on Aug. 7, 2003 which is incorporated herein by reference in its entirety.

The present invention relates to the field of engineering and wire manufacturing processes and is particularly applicable to welding equipment with mechanical wire feed used in arc welding methods.

A known method of feeding a welding wire consists of pressing the wire between the drive and the pressure rollers and, while pushing it in the guide groove, creating conditions enabling the wire to engage in translatory motion in the required direction.

To provide the necessary pushing force, the wire has point contacts with the pressure rollers and is subjected to considerable radial pressure. At the same time in order to overcome the resistance exerted onto the wire travelling along the guide grooves, either the pressure on the wire between the pair of rollers has to be increased up to its critical point, which crushes the wire and destabilizes its feed, or the number of the pairs of rollers exerting pressure onto the wire has to be doubled in order to maintain the shape of the cross-section of the wire. In this case, no significant increase in the pushing force for the wire is achieved, and the design of the respective device becomes more complicated (U.S. Pat. No. 2,125,926 to the Lincoln Electric Company, B23K9/12).

There is also a known method of feeding a welding wire with a drive roller and a pressing-in joint, consisting of engaging the wire with the pressing-in joint and with the guide groove of drive roller along the arc. The arc is confined by the span of 0.01-1.0 of the wire diameter, the arc length is controlled by changing the distance between the farthest points at which the pressing-in joint contacts the feeding wire (Russian Federation Pat. No. 2012460 dated 15.05.1994, B23K9/12).

The technical nature and accomplished result of the above-described method is the closest existing art to the present invention. The method provides for high pushing forces exerted on the wire, allowing for an increase in the effective range of the welding torch and for an extension of the diameter range of the feeding wire. In accordance with the above-described method, the wire engages with the guide groove of the drive roller along a rather short length of drive roll circumference. As a result, the drive roller must be of a very large diameter approaching the residual curvature diameter of the spooled wire (at least 80 diameters of the wire). Under such conditions, the above-described method allows simultaneous straightening of the residual bending of the wire caused by the spool, which prevents the wire contraflexure.

There are various known wire feeding devices with the grooved drive roller.

In the known devices the wire is fed by the two pairs of rolls interconnected with the gear wheels mounted on each of the roller-bearing shafts.

Such all-roller-drive double-paired device has a number of the following significant shortcomings.

Balance of linear speeds between the rollers in each pair and particularly between the pairs of rollers is hard to achieved. Such disbalance in linear speeds leads to: slippage of the rollers at high linear speeds when a low pressure is exerted on the wire; destabilization of the wire feed; slowing down one of the roller pairs; slippage and resistance of a roller pair to pushing the wire by the other pair of rollers when a normal pressure is exerted onto the wire.

An increase in forces applied to the wire between the roller pairs in view of its feed stability enhancement requires a sophistication of the mechanism design and an amplification of its electric drive power, as in this case it becomes necessary to counteract a “bulging” effect in the wire. To overcome this effect, a special guiding plates unit was introduced into the feed mechanism, including a guiding plate with a guiding slot covered with a separate plate in order to form a groove for the wire to pass through the entire device (before, after and between the roller pairs ) (The Lincoln Electric Company Pat. No.2125926, B23K9/12).

Although such sophistication of the design somewhat increases the wire feed stability, it does not eliminate certain shortcomings, the most significant of which are: the absence of synchronism between the linear speeds of feed rolls, the existence of point contacts between the wire and feed rolls, which prevents the application of significant pushing forces against the wire, the absence of precision wire straightening, increased power of electric drives, significant sophistication of the mechanism and an increase in its weight and external dimensions.

In terms of its technical nature the most similar to this device, in connection with the present invention related to wire feed, is the device including: a drive roll with the guide groove; a mechanism of pressing-in the wire into the drive roll guide groove, and a wire straightening mechanism (Russian Federation Pat. No. 2012460, B23K9/12).

The goal of the present invention is to develop an efficient and reliable wire feed method using the drive roll, and to create the corresponding mechanical device.

The technical task consists in the achievement of enhanced pushing forces, required for wire feed at longer distances and for high-quality wire straightening.

In addition, a simplification of the design is ensured, as well as a reduction in the weight and external dimensions of feed mechanisms, production costs, as well as enhanced engineering capabilities and applications of the device.

The objective is achieved as follows: before its entry into the drive roll guide groove, the wire is bent at an angle equal to at least 0.5° from a tangent to a circle passing through the point of the wire entry into the guide groove between the said tangent and the wire axis and the wire is pushed into the guide groove using a bending force; engagement between the wire and the guide groove is maintained on a section of length equal to at least one wire diameter and no more than the guide groove length, and the wire is straightened by contraflexure bending, at an angle equal to at least 0.5° from the tangent to a circle, passing through the point where the wire disengages from the guide groove between the said tangent and the axis of the wire. The wire is then driven in the required direction.

In addition, to achieve the specified objective, the following is performed:
the wire is guided into the drive roll guide groove by means of the pressing-in and straightening mechanism equipped with two pressing-in components;
the wire is guided into the drive roll guide groove by the first pressing-in component of the pressing-in and straightening mechanism, and after it has engaged with the groove it is brought into engagement with the second pressing-in and straightening mechanism;
the force of pressing the wire into the drive roll guide groove is adjusted as follows: by changing the wire length between the points of its disengagement from the first pressing-in component of the pressing-in mechanism and its engagement with the guide groove; bychanging the angle formed with a tangent to a circle passing through the point of the wire engagement with the guide groove between the said tangent and the wire axis, and by changing the wire length between the points of its disengagement with the first pressing-in component and engagement with the second one;
the engagement of the wire with the drive roll guide groove is maintained by setting the wire length at which the uniformly distributed force of pressing the wire into the guide groove is maintained, due to the rigidity of the wire;
the engagement of the wirer with the drive roll guide groove is maintained by means of its passage between the wire position stabilizer and the drive roll guide groove (the engagement of the wire with the drive roll guide groove is maintained by the supplementary mounted stabilizer of the wire position);
the wire is passed between the drive roll guide groove and the wire position stabilizer which is mounted prior to the point of the wire disengagement from the drive roll guide groove;
the wire is passed between the drive roll guide groove and at least two wire position stabilizers, which are mounted after the point where the wire engages with the guide groove, and before the said disengagement point;
the wire is passed between the drive roll guide groove and the stabilizer which is mounted at a point located above one half of the circumference of the drive roll;
the wire engages with the drive roll guide groove, describing a spiral trajectory, bending the wire around 360° of the drive roll circumference;
a tensional force is applied to the wire in a direction opposite to it's the wire feed;
the engagement of the wire with the guide groove is maintained by mounting the wire position stabilizer after the point of its engagement, and before the point of its disengagement from the guide groove.

The mechanical device designed to implement this wire feed method includes a drive roll with a guide groove, and a wire pressing-in and straightening mechanism equipped with pressing-in components.

The device differs from the known one, in that the pressing-in components are arranged on either side of the wire engagement and drive roll guide groove location, acting as end stops for the wire and being designed so as to enable travel as regards the drive roll. The drive roll is an intermediate rotating bearing and the pressing-in component, which contacts the wire after it has disengaged from the drive roll guide groove, is arranged in the wire flexure plane at an angle of at least 0.5° from the tangent to a circle passing through the point of the wire disengagement from the guide groove between the said tangent and the wire axis, thus acting as a stop straightening component.

The pressing-in components can be designed in the form of rollers or feed-through bushings capable of travelling in the wire flexure plane and along the wire.

One of the pressing-in components can be designed in the form of a roller and the other—as a feed-through bushing.

At least one auxiliary wire positioning stabilizer can be mounted in the device, for stabilizing the wire pressed into the drive roller guide groove.

The wire position stabilizer can be designed as a block with a radius of the wire curvature and length equal to at least two diameters of the wire, and mounted before the point where the wire disengages from the guide groove.

The stabilizer for positioning the wire in the drive roller guide groove can be designed to have a polygon profile with a number of working surfaces in its cross-section being equal to the number of its faces.

The wire position stabilizer can also be designed in the form of a flat band or strip with one end fixed, and coming in contact with the wire at the point of its disengagement from the drive roller guide groove, and the other end being connected to the tension mechanism, with the band bending round at least one eighth of the external circumference of the drive roller and at no more than half its circumference.

In some cases, the drive roller can be designed as a screw with a guide groove describing one rotation, with pitch equal to at least one diameter of the wire. In this instance, the pressing-in components should be designed as feed-through bushings arranged in different planes, where their respective axes are displaced by a distance of at least the pitch of the drive roller guide groove, being capable of transverse travel of a distance at least equal to the wire diameter.

The device can include at least one auxiliary pressing-in and straightening mechanism for simultaneous feed of several wires with all mechanisms arranged around one drive roller.

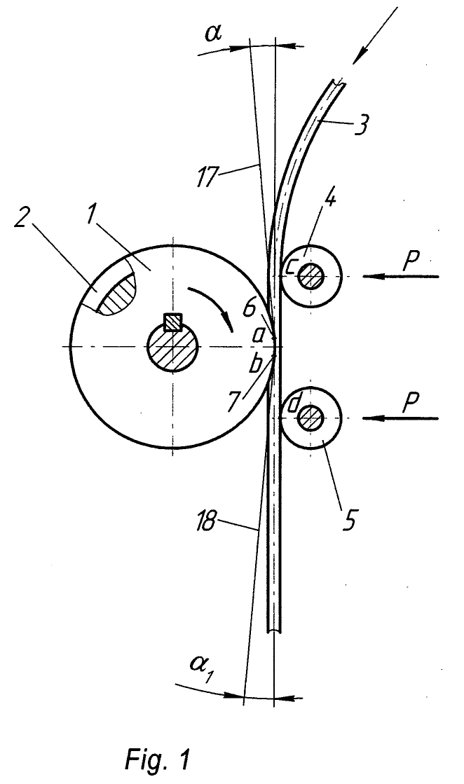

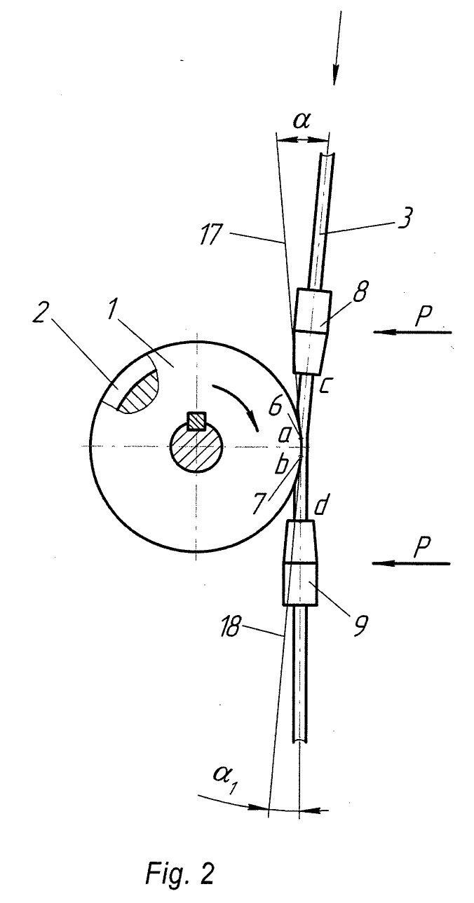

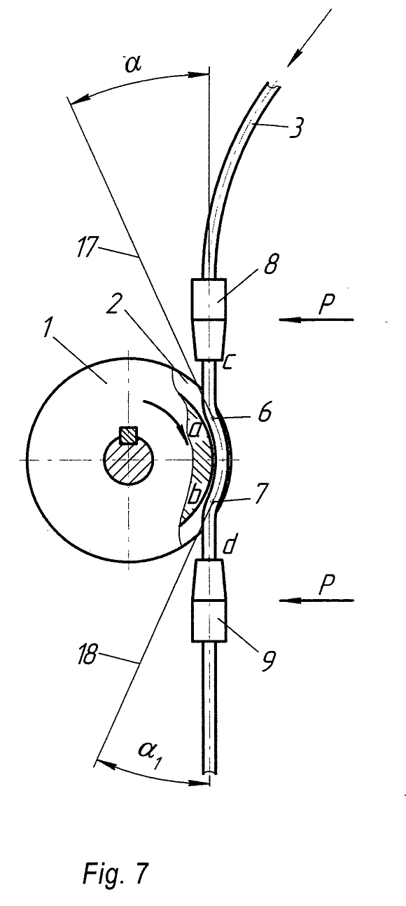

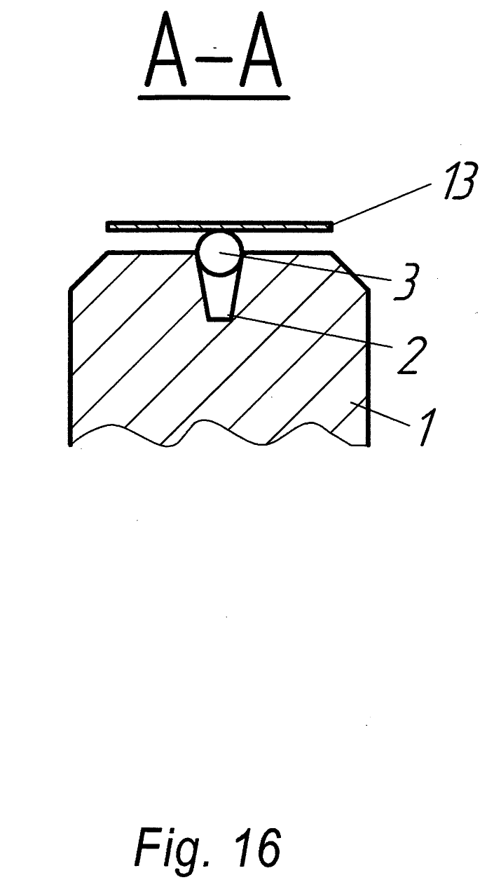

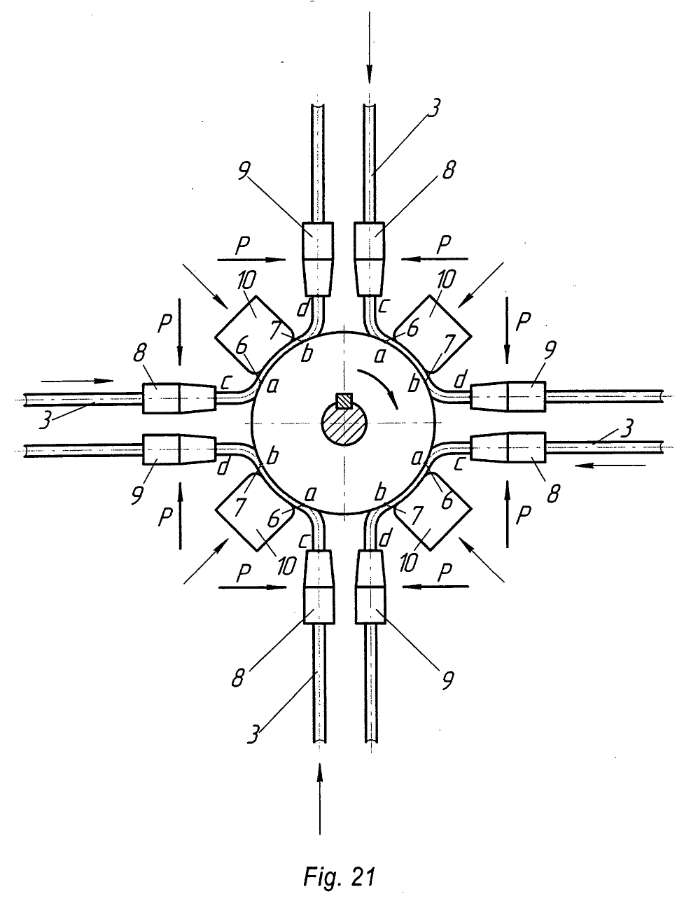

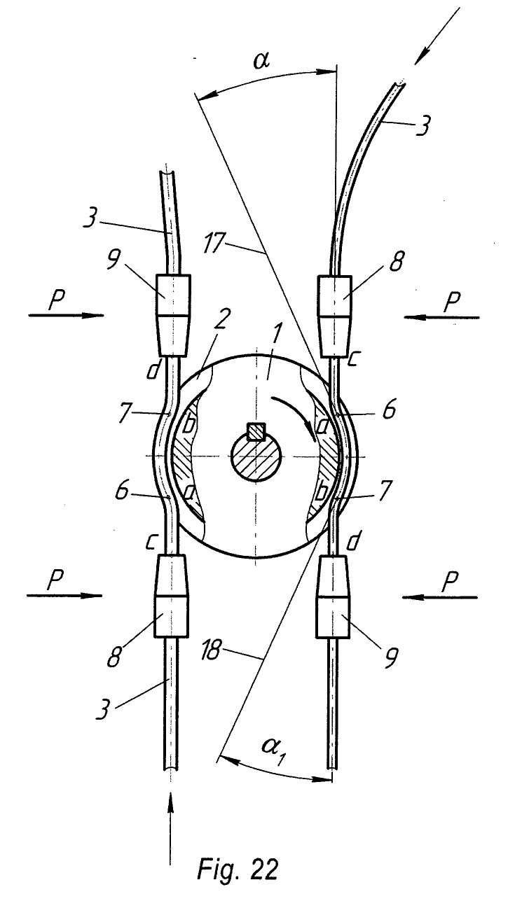

One possible design for the present invention is shown in FIG. 1, and other alternative designs of the invention are shown in FIGS. 2 to 23.

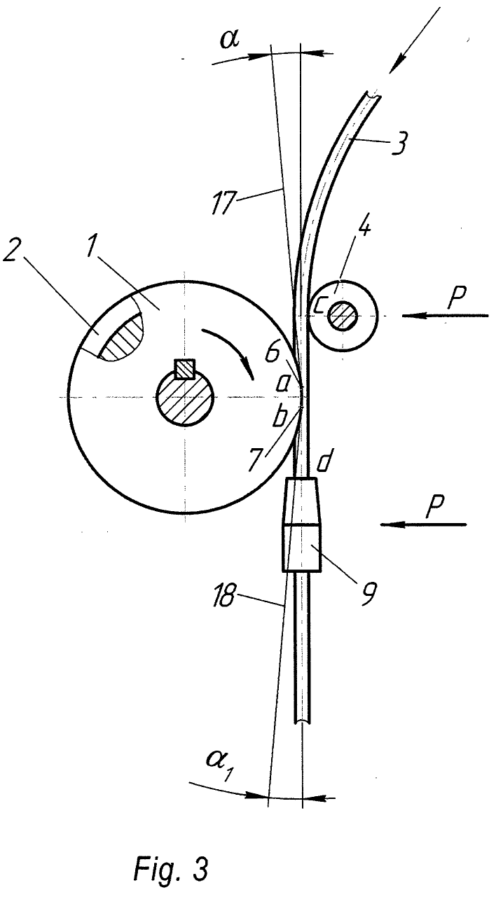

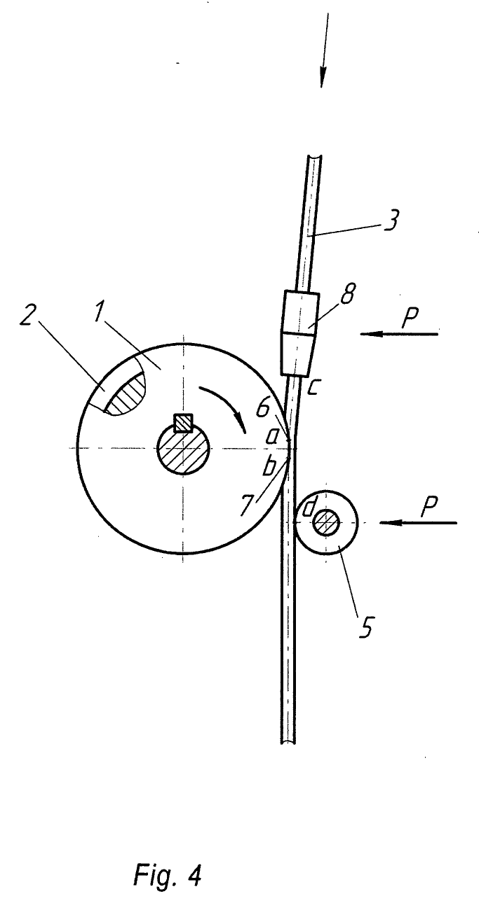

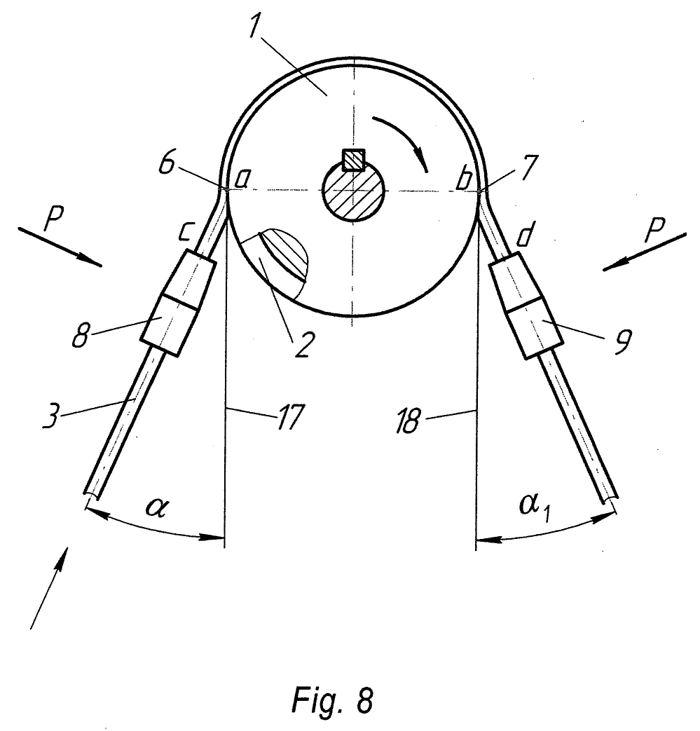

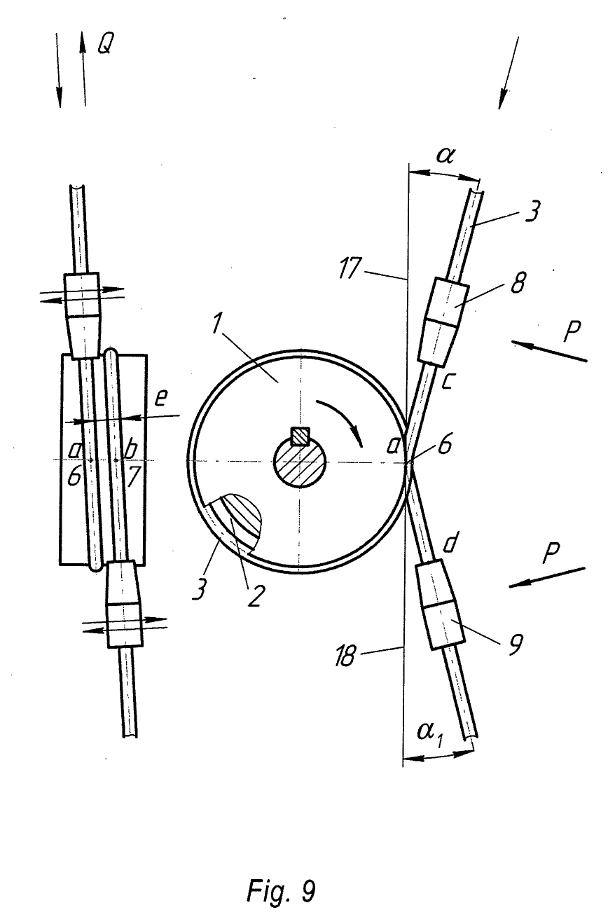

The design (FIG. 1) includes a drive feed roller, 1, with a guide groove, 2, which comes in contact with the wire, 3, on the section “a-b” using the pressing-in components 4 and 5 of the pressing-in mechanism (not shown). The pressing-in components can be designed both in the form of rollers 4 and 5 (FIG. 1) and the feed-through bushings 8 and 9 (FIG. 2). They can be of equal (FIGS. 1 and 2) or different diameters in a pair (FIGS. 3 and 4). The pressing-in components are arranged outside the area where the wire engages with the guide groove of the drive roller, 1, on either side of its diametral axis passing through the section “a-b” at an equal or different distance from the axis. Depending on the diameter of the wire, 3, and the feed forces required, the length of the section “a-b”, on which the wire 3 tightly engages with the guide groove 2, will range from one wire diameter, 3, (FIGS. 1 to 4 and 6) to the full length of the guide groove (FIGS. 8 and 9).

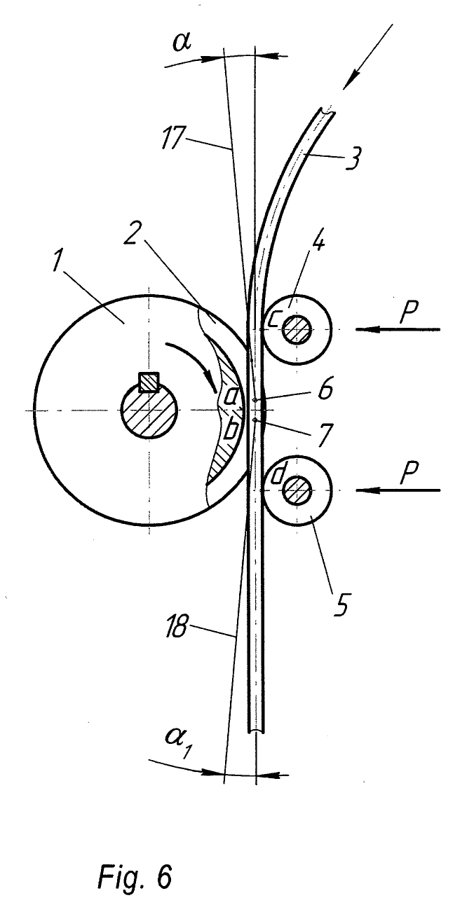

The wire, 3, can project out of the groove, 2, over the surface of the drive roller, 1, (FIGS. 1-5, 8-21) or it can be submerged in it (FIGS. 6, 7, 22).

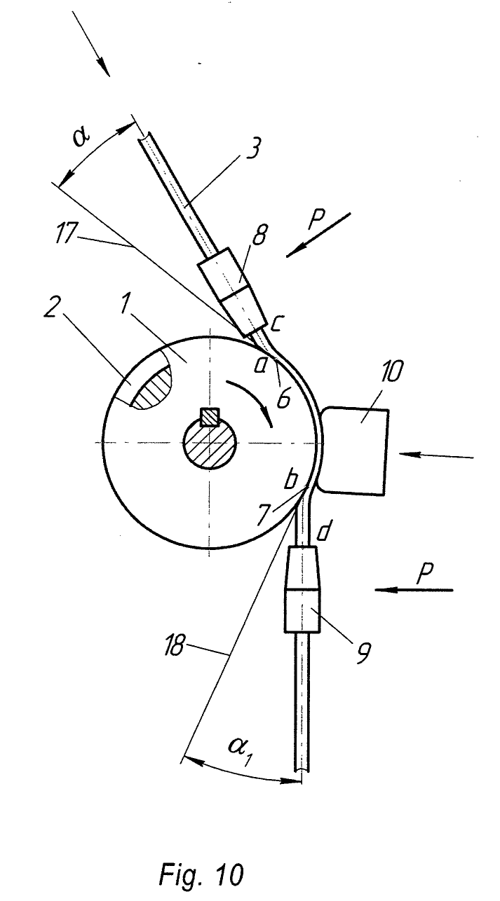

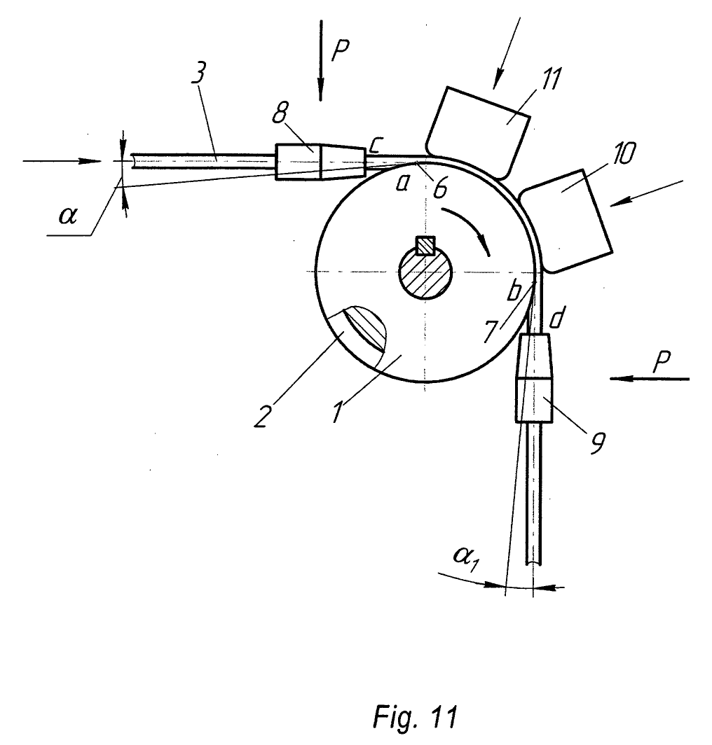

In alternative designs, where the longest sections “a-b” of engagement between points 6 and 7 are provided for maintaining engagement of the wire, 3, with the guide groove, 2, and preventing “bulging” of the wire before the point of its coming in contact with the second pressing-in component 5 or 9, the wire position stabilizer 10 is mounted, which tightly adjoins the wire describing its outer curvature (FIG. 10). The same position stabilizer of the wire, 3, can be mounted after the point where the wire, 3, disengages from the first pressing-in component, 4 or 5 (FIG. 11).

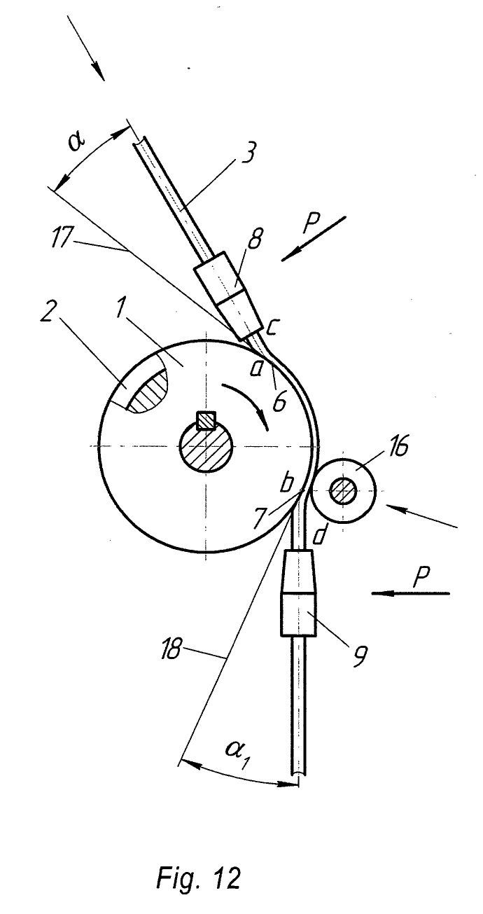

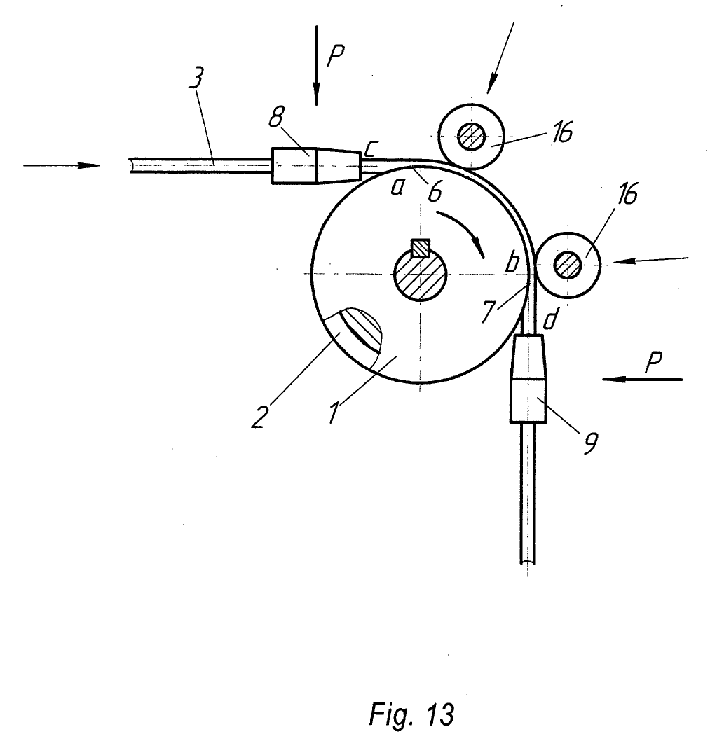

Stabilizers in the form of rollers, 16, (FIGS. 12 and 13) can also be successfully used.

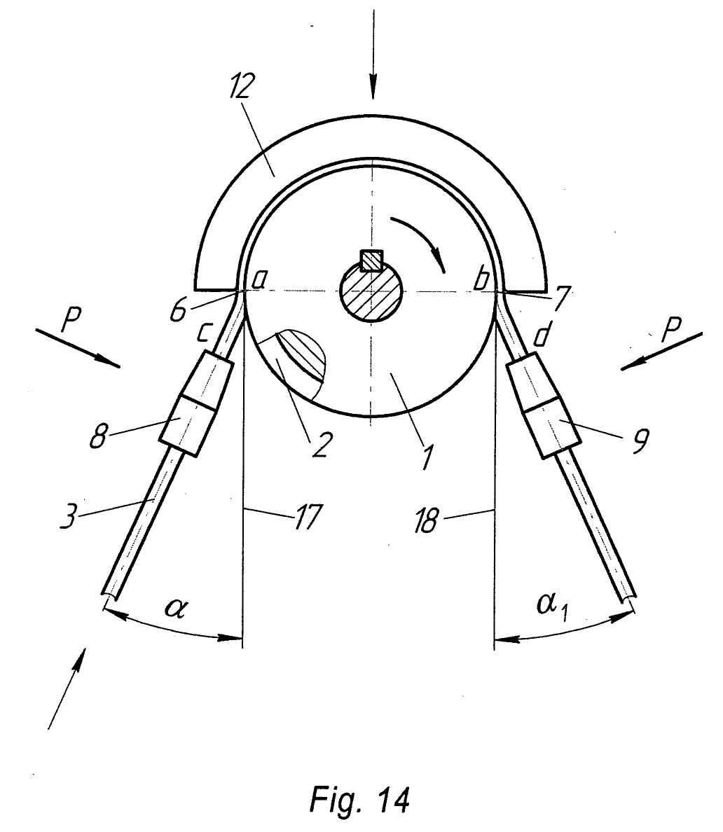

In case of maintaining secure engagement between the wire, 3, and the guide groove, 2, the length of its section “a-b” being equal to half the perimeter of the drive roller, 1, the mounted stabilizer, 12, has a working end of the same length and describes the outer curvature of the wire, 3, to be pressed into the groove, 2 (FIG. 14).

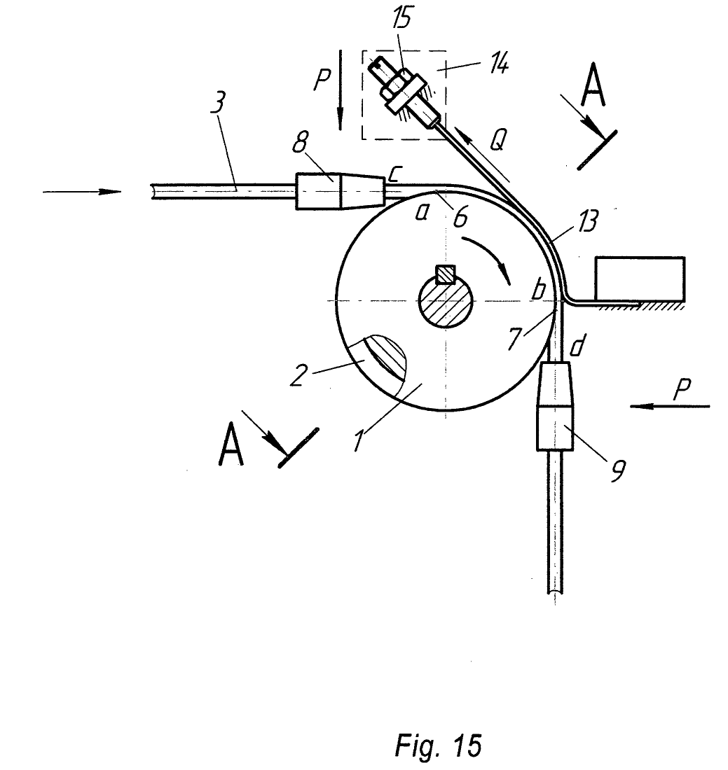

In order to transmit significant pushing forces from the drive roller, 1, to the wire, 3, an alternative modification of the stabilizer, 13, is feasible, designed as a band or strip (FIGS. 15-17) with one of its ends fixed before the point 7, where the wire disengages from the drive roller, 1, and with the other end fixed in the tension mechanism, 14.

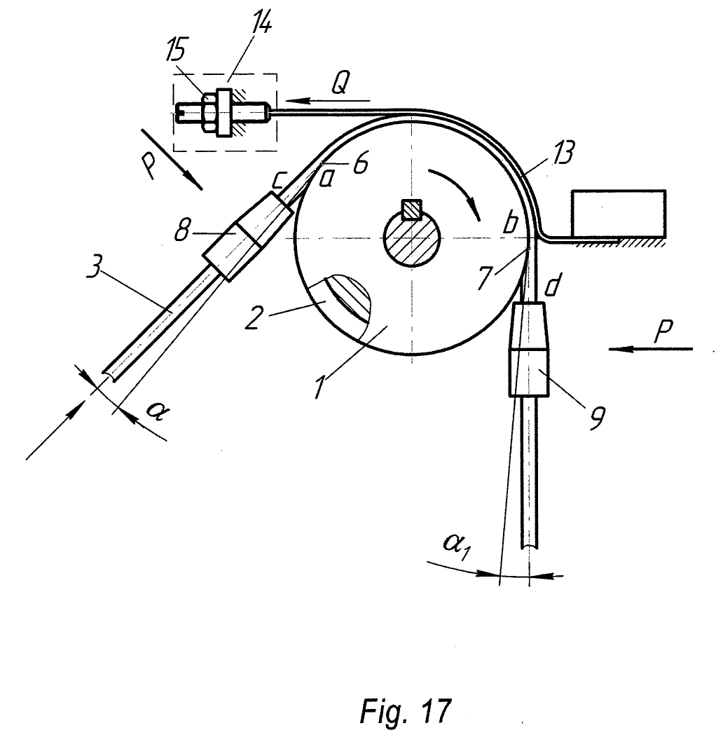

When the stabilizing block, 12, replaces the stabilizing band, 13, the tension mechanism, 14, ensures that the stabilizing band, 13, fits tightly against the outer surface of the wire, 3, where the length of the section “a-b” between the points 6 and 7—between the engagement of the wire, 3, with the guide groove, 2, and the drive roller 1, can be adjusted in the range of between one eighth and one fourth of the length of the guide groove, 2, (FIGS. 15 and 17) to half the length of the guide groove, 2.

The tension mechanism, 14, is provided with a radial travel device (not shown) and a screw pair, 15, for the purpose of securing travel of the mechanism for the purposes of adjusting the device.

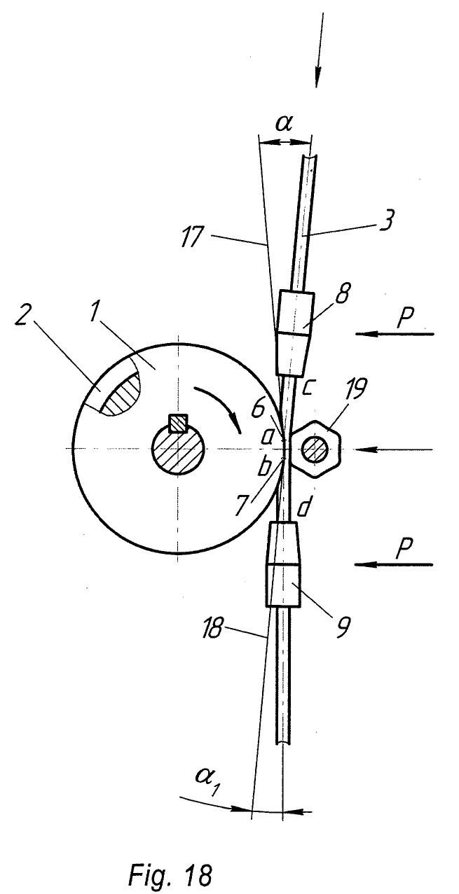

The design of the stabilizer, 19, (FIG. 18) of the position of the wire, 3, in the groove, 2, in cases of increased wear of the working face can include a cross-section designed in the form of a polyhedron with at least four faces. Such a stabilizer is equipped with a rotating device (not shown), which assists in replacing one working face with the another.

In order to feed relatively thin wires, an alternative design of the present invention is proposed, in which the wire, 3, is bent in a screw path by the working surface of the drive roller, designed as a single-turn screw with the pitch “e” between the start and end of the groove, 2, being equal to at least one diameter of the wire, 3 (FIG. 9). In this design, tight engagement between the wire, 3, and the groove, 2, can be ensured by the tension force Q of the wire, 3, while it is being reeled out of a spool by the traditional application of a spool braking device (not shown).

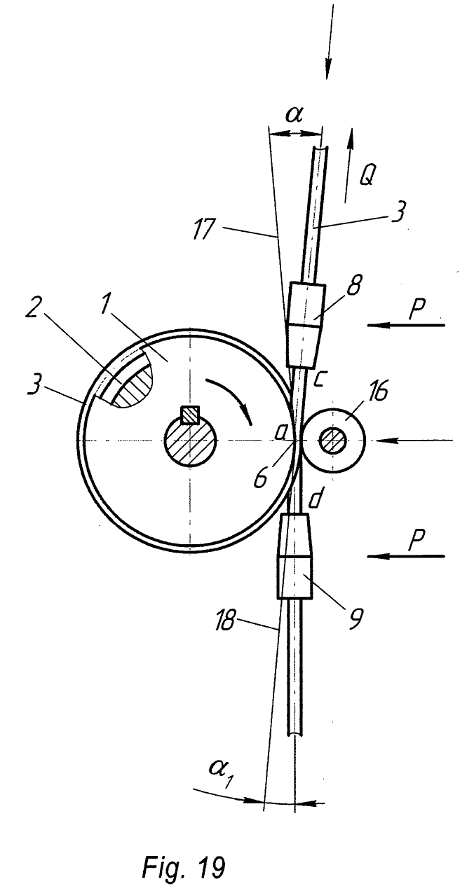

A stabilizer designed, for instance, as a roller, 16 (FIG. 19) or any other design of the above alternative solutions, etc., can be mounted before the point where the wire engages with the second pressing-in component, 9, and after the point where it disengages from the first pressing-in component, 8, so as to prevent possible “bulging” of the wire.

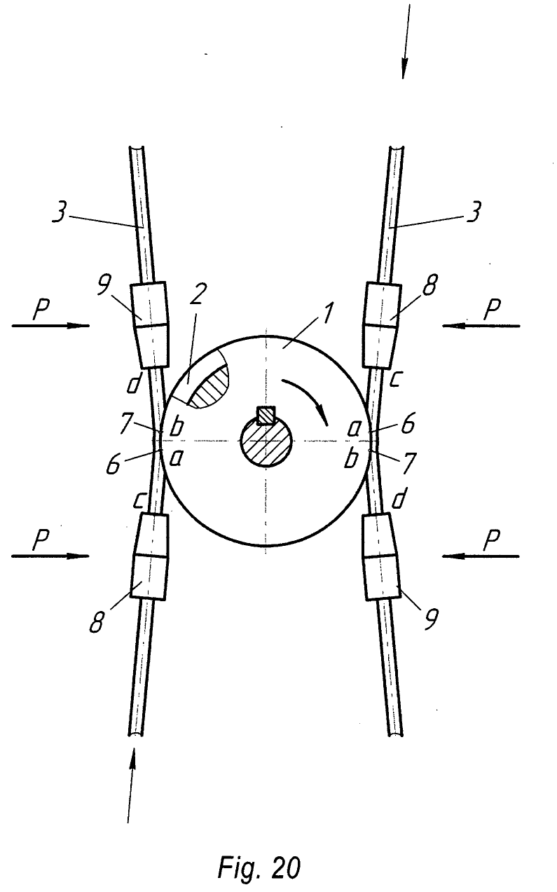

If it is required that more than one wire of the same or different diameters should be fed, the alternative design of the present invention will include two or more pressing-in and straightening mechanisms, respectively (FIGS. 20 to 22).

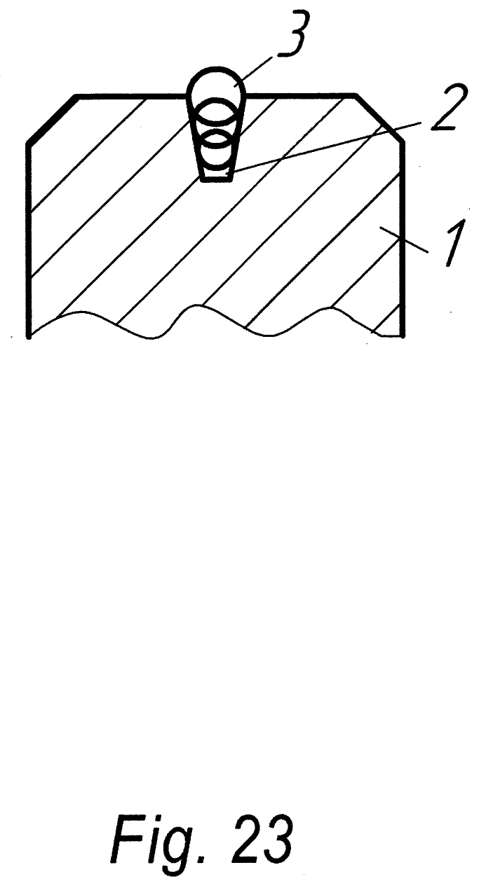

In order to feed the wire, 3, of different diameters, the drive roller, 1, includes the guide groove, 2, the cross-section of which is sufficiently large to hold at least one wire, 3, of the largest diameter (FIG. 23).

The proposed design of the present invention is implemented as follows.

When reeled out of the spool (not shown), the previously-bent wire, 3, is guided to the drive roller, 1 (FIG. 1) by means of the first pressing-in component, 4, of the pressing-in mechanism, at the external angle of α=0.5° from the tangent, 17, to a circle passing through the point, 6, where the wire, 3, enters the drive roller guide groove, 1.

Further, using an electric drive (not shown) the drive roller, 1, is rotated; in this case, the wire, 3, is bent and pressed, with the force, P, transmitted through the point “c” into the guide groove, 2, to come into tight engagement with the groove, 2, on the section “a-b” between the points 6 and 7 and, having a high factor of friction with the groove, 2 (e.g., in cases when the groove, 2, is wedge-shaped and has a small angle between its edges), describes a translatory motion, disengages from the drive roller 1, through the point 7, and comes in contact at point “d” with the second pressing-in component, 5, which bends the wire, 1, in the opposite direction and guides it at an external angle of α₁=0.5° to the tangent, 18, which passes through the point, 7, where the wire, 3, disengages from the drive roller, 1. In this case, the wire, 3, is carefully straightened and fed in the direction required.

The pressing-in components can be designed in the form of both rollers, 4 and 5, (FIG. 1) and feed-through bushings, 8 and 9 (FIG. 2). Alternative combinations are feasible where one of the pressing-in components is designed as a roller, and the other as a feed-through bushing (FIGS. 3 and 4).

All the above alternative designs of pressing-in components can be used to feed the wire, 3, across the entire range of existing diameters.

Depending on the pushing forces required to be applied to the wire, 3, it is guided by the components 4 or 8 into the guide groove 2 of the drive roller 1 at one or another angle α with the tangent 17 to a circle passing through the point, 6, where the wire, 3, engages with the drive roller, 1.

In this case, the larger the angle a is, the greater are the forces applied to the wire, 3.

In addition, the pushing forces applied to the wire, 3, depend to a significant degree on the length of the wire, 3, between the point “c” of the disengagement of the wire, 3, from the pressing-in components 4 or 8, and the point 6, where the wire engages with the guide groove, 2, of the drive roller, 1, i.e., the shorter this section is, the greater the pushing forces applied to the wire, 3.

At the same time, if the wire, 3, is guided at an angle of α=0.5° through point 6, to be engaged with the guide groove, 2, and is pressed in with the force P in the section “a-b”, within the area of single-point contact, the minimum pushing forces will be applied to the wire, 3, and the maximum pushing forces will be applied at the section with linear contact.

In the first instance (FIGS. 1-4, 6, 18 and 20) the section “a-b” of engagement of the wire, 3, with the guide groove, 2, does not exceed, in terms of length, one diameter of the wire, 3, even given the maximum force P of pressing-in the wire, 3, by component 4.

The resulting bend of the wire, 3, when it enters point 6, is immediately eliminated when the wire, 3, leaves point 7 by virtue of contraflexure applied by the components 5 or 9, which deflects the wire at the angle α=0.5° to the tangent of a circle passing through point 7, where the wire, 3, disengages from the drive roller, 1.

In this way, straightening of the wire, 3, is achieved.

Generally, in this instance point 6, where the wire, 3, engages and point 7, where it disengages from the drive roller, 1, almost coincide, and are arranged on a somewhat protracted section, which is nevertheless within the range of one diameter of the wire.

The angles α and α₁ have relatively small values in this case, and constitute at least 0.5°, when the wire is rigid enough or when it has a larger diameter and is comparatively straight.

This solution for engagement of the wire, 3, with drive roller 1 can be successfully applied to the wire feed, e.g., in automatic welding machines.

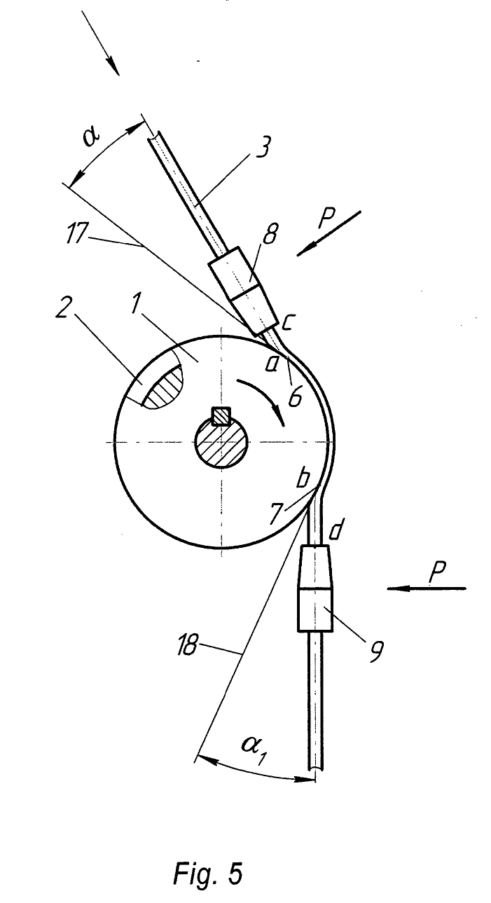

In the second instance (FIGS. 5, 7-19 and 21-22), the section “a-b” where the wire, 3, engages with the guide groove, 2, of the drive roller, 1, has greater length than one diameter of the wire, and can even reach the full magnitude of the circumference of the drive roller. In this case, the longer the section “a-b” is, the greater force, P, can be used to press the wire, 3, into the guide groove, 2; and the maximum pushing forces can be achieved and applied to the wire, 3, without any loss in the quality of its surface, and without deformation of its cross-section. This arrangement is quite favourable for flux-cored wires (in welding) or thin-walled tubes (in other engineering applications), and also for solid wires made of non-ferrous metals and their alloys.

Particular advantages are achieved in this case by feeding thin wires at long distances with considerable resistance to their travel in the specified direction along flexible guide channels, e.g., in MIG/MAG welding. In this case, considerable resistance to the wire when it enters the guide channel should be easily overcome by the application of excessive pushing force to the wire, 3, on the section “a-b” of its engagement with guide groove 2. In addition, if the section “a-b”, located between the points 6 and 7, where the wire, 3, engages and disengages the drive roller, 1, is of considerable length, in order to prevent slackening of the engagement of the wire, 3, with the groove, 2, or even to prevent it from moving beyond the groove (“bulging”), the stabilizer, 10 (FIG. 10) should be mounted before point 7, so as to maintain engagement of the wire, 3, with the guide groove, 2, of the drive roller, 1. If necessary, in order to maintain the position of the wire, 3, within the groove, 2, the same stabilizer, 11 (FIG. 11) can be mounted directly after the location where the wire, 3, enters point 6, where it engages with the groove, 2, or can even be arranged between the points 6 and 7, occupying half the length of the guide groove, 2, in terms of the length of the working face (pos. 12, FIG. 14).

Moreover, stabilizers 10 and 11 can be replaced with a roller, 16, (FIG. 12 and 13) in order to reduce friction.

The stop component, 9, can be used for straightening the wire, 3, which is engaged at the section “a-b” with the guide groove, 2, and has length exceeding one diameter of the wire, up to the same length equal as that of the guide groove (FIGS. 5, 7-15, 17, 19, 21 and 22).

In this case, the wire, 3, which has disengaged from the guide groove, 2, by means of contraflexure with the components 5 or 9, is guided at an external angle exceeding 0.5° to a tangent of a circle passing through the point 7, where the wire disengages from the guide groove of the drive roller, 1.

Owing to the simplicity of this engineering solution, the proposed method can be successfully implemented in cases when it is required that two or more wires of the same or different diameters should be fed in a specified direction (FIGS. 20 to 22).

The advantages of the method, and the device designed for its implementation, lie in the expansion of the engineering capabilities and the broadening of fields of application, while the solutions deployed are nevertheless relatively simple.

1. A method of feeding a wire comprising:
guiding the wire into the guide groove of a drive roller at an entry point of the wire into the guide groove, the wire being bent at an angle of at least 0.5° relative to a tangent to the circumference of the drive roller at the entry point;
pressing the wire into the guide groove of the drive roller and bending the wire to engage the wire with the guide groove;
maintaining the engagement of the wire with the guide groove along a portion of the guide groove, the portion having the length ranging from at least one wire diameter to the circumference of the guide groove;
disengaging the wire from the guide groove of the drive roller at an exit point of the wire out of the guide groove, straightening the wire by bending and guiding the wire away from the drive roller at an angle of at least 0.5° relative to a tangent to the circumference of the drive roller at the exit point.

2. The method as defined in claim 1, wherein guiding the wire into the guide groove of the drive roller comprises utilizing a pressing-in and straightening joint with two pressing-in components.

3. The method as defined in claim 1, wherein guiding the wire into the guide groove of the drive roller by utilizing a first pressing-in component of the pressing-in and straightening joint, engaging the wire with the guide groove and guiding the wire through the guide groove, and engaging the wire with the second pressing-in and straightening joint.

4. The method as defined in claim 1, further comprising controlling the force of pressing the wire into the guide groove by changing the length of the wire between a point of disengagement of the wire from the first pressing-in component and the entry point, altering the angle formed by a tangent to the circumference of the drive roller at the entry point and the wire axis, and by changing the length of the wire between a point of disengagement between the wire and the first pressing-in component and a point of engagement between the wire and the second pressing-in component.

5. The method as defined in claim 1, wherein maintaining the engagement of the wire with the guide groove comprises setting the length of the wire engaged with the guide groove such that the force of pressing is uniformly distributed over the length.

6. The method as defined in claim 1, wherein maintaining the engagement of the wire with the guide groove comprises passing the wire between a position stabilizer and the guide groove.

7. The method as defined in claims 6, wherein passing the wire between the guide groove and the position stabilizer comprises disposing the stabilizer before the exit point.

8. The method as defined in claim 7, wherein passing the wire comprises passing the wire between the guide groove and at least two wire position stabilizers disposed after the entry point and before the exit point.

9. The method as defined in claim 6, wherein passing the wire between the guide groove and the stabilizer comprises mounting the stabilizer above a half-circumference of the drive roller.

10. The method as defined in claim 6, wherein the wire engages with the guide groove along a spiral path, bending the wire along 360° circumference of the drive roll.

11. The method as defined in claim 10, further comprising applying a tension force to the wire in a direction opposite to its feeding direction.

12. The method as defined in claim 1, wherein maintaining the engagement of the wire with the guide groove comprises mounting a wire position stabilizer after the entry point and before the exit point.

13. A device for feeding a wire comprising:
a drive roller with a guide groove serving as an intermediate rotating bearing;
a straightening mechanism made as a stop element;
an engaging device for engaging the wire with the guide groove, the engaging device made as a pressing-in joint for pressing the wire into the guide groove, the pressing-in joint comprising at least two pressing-in components in the form of end stops disposed on both sides of a zone of engagement between the wire and the guide groove, the pressing-in components are displaceable along the drive roller.

14. The device as defined in claim 13, wherein both pressing-in components are rollers.

15. The device as defined in claim 13, wherein both pressing-in components are feed-through bushings displaceable in the wire flexure plane and along the wire.

16. A device as defined in claim 13, wherein one of the pressing-in components is a roller and the other pressing-in component is a feed-through bushing.

17. A device as defined in claim 13, further comprising at least one stabilizer of a position of the wire pressed into the guide groove.

18. The device as defined in claim 17, wherein the stabilizer is a block with a working end having a working end curvature matching an external curvature of the wire, the length of the working end curvature being equal to at least two diameters of the wire, the stabilizer being mounted before the point of the wire disengagement from the guide groove.

19. The device as defined in claim 17, wherein the stabilizer is a flat band or a strip having two ends, wherein the first one end is fixed and contacts the wire at the point of the wire disengagement from the guide groove, and wherein the second end is coupled to the tension mechanism, and wherein the band or a strip wraps around at least one eighth of an outer circumference of the drive roll and at most a half of the outer circumference.

20. The device as defined in claim 13, wherein the drive roller is a screw with a guide groove in the form of one flight with a pitch equal to at least one diameter of the wire.

21. The device as defined in claim 20, wherein the pressing-in components are designed as guiding and receiving bushings disposed in different planes, the pressing-in components being axially displaced by the length to at least the pitch of the guide groove, the pressing-in components being transversely displaceable by the length equal to at least the wire diameter.

22. The device as defined in claim 13, further comprising at least two pressing-in joints disposed along the drive roller for simultaneously feeding the number of wires equal to the number of pressing-in joints.

23. The device as defined in claim 17, wherein the stabilizer is a polygon with a number of faces equal to a number of effective surfaces in the cross-section of the polygon.
